(19) United States
(12) Patent Application Publication
(10) Pub. No.: US 2011/0261365 A1
(43) Pub. Date: Oct. 27, 2011

(54) OPTICAL SPECTROSCOPY DEVICE INCLUDING A PLURALITY OF EMISSION SOURCES

(75) Inventors: Stephane Tisserand, Marseille (FR); Marc Hubert, Aix en Provence (FR); Laurent Roux, Marseille (FR)

(73) Assignee: SILIOS TECHNOLOGIES, Peynier (FR)

(21) Appl. No.: 13/133,934

(22) PCT Filed: Dec. 10, 2009
(86) PCT No.: PCT/FR2009/001407

§ 371 Date: Jul. 13, 2011

(30) Foreign Application Priority Data
Dec. 11, 2008 (FR) 0806957

(51) Int. Cl. G01J 3/45

(52) U.S. Cl. 356/451

(57) ABSTRACT

The invention relates to a wavelength spectroscopy device comprising, on a substrate a filter cell CF constituted by two mirrors separated by a spacer membrane, the filter cell being made up of a plurality of interference filters. Furthermore, the device also comprises an emission cell CE comprising a plurality of emission sources, each of said sources being associated with one of said interference filters.

The present invention relates to an optical spectroscopy device including a plurality of emission sources.

The field of the invention is that of spectrometric analysis seeking in particular to use a light source to find chemical constituents included in the composition of a solid, liquid, or gaseous medium. The idea is to record the absorption spectrum of the medium in reflection or in transmission. The light that interacts with the medium is absorbed in certain wavelength bands. This selected absorption is a signature of some or all of the constituents of the medium. The radiation of the spectrum to be measured may lie in the ultraviolet, and/or the visible, and/or the infrared (near, medium, far) wavelength range or ranges.

A first solution makes use of a grating spectrometer. In such an appliance, the grating acts as a filter that is located at a considerable distance from the detector. Resolution is increased with an increase in this distance. It follows that the appliance cannot be miniaturized if it is desired to conserve acceptable resolution. In addition, the appliance is complicated to adjust and difficult to make stable since it requires accurate optical alignment.

Most other spectrometers make use of at least one Fabry-Perot filter.

As a reminder, such a filter is a parallel-faced plate of a material (usually having a low refractive index, such as air, silica, . . . ) referred to as a spacer membrane or more simply as a “spacer”, which membrane lies between two mirrors. It is often made by vacuum deposition of thin layers. Thus, for a filter having its passband centered on a center wavelength λ, the first mirror consists in n alternations of layers having an optical thickness λ/4 of a high-index material H and of a low-index material B. The spacer membrane frequently consists of two layers of low-index material B having an optical thickness λ/4. In general, the second mirror is symmetrical to the first. Modifying the geometrical thickness of the spacer membrane enables the filter to be tuned to the center wavelength at which the optical thickness is equal to a multiple of λ/2.

In some circumstances, a finite number of relatively fine passbands (i.e. using a spectrum that is discrete as opposed to a spectrum that is continuous) suffices to identify the looked-for constituents, such that the first above-mentioned solution is not optimized.

A second known solution provides for using a filter cell having one individual filter per band to be analyzed. If the number of bands is n, making n filters thus amounts to n distinct fabrication operations involving vacuum deposition. Cost is then very high for short runs (being almost proportional to the number n of bands), and it becomes genuinely advantageous only for runs that are long enough. Furthermore, here likewise, any possibility of miniaturization is very limited and it is difficult to envisage providing a large number of filters.

A third known solution implements a Fabry-Perot filter presenting a profile in a plane perpendicular to its substrate that is wedge-shaped. Thus, document US 2006/0209413 is known that teaches a spectrum analyzer having a profile of this type. In the plane referenced Oxy, with the axes Ox and Oy being respectively collinear with and perpendicular to the substrate, the thicknesses in the Oy direction of the mirrors and of the spacer membrane vary linearly as a function of the Ox position at which they are measured. This defines a filter cell having a linear structure (one dimension) or a matrix structure (two dimensions) comprising a plurality of individual filters that are practically monochromatic. Detection is performed by means of an incorporated detection cell superposed on each filter cell, the detection cell being provided with a plurality of individual detectors that coincide with the plurality of individual filters.

In such a configuration, fabricating the filter cell is firstly very difficult in terms of controlling the “thin layer” method. Secondly, fabricating a plurality of filters collectively on a common wafer gives rise to great difficulties of reproducibility from one filter to another. Thirdly, the continuous variation in thickness may indeed present an advantage under certain circumstances, but it is poorly adapted to circumstances in which a detector needs to be centered on a well-defined wavelength. The size of the detector means that it detects all wavelengths lying between those on which its two ends are tuned. Once more, low-cost mass production is not very realistic.

In such a configuration, the detection cell would appear to involve a plurality of individual detectors. Firstly, such a configuration is advantageous only if it is possible to integrate the detectors, and that is not always possible. Secondly, such a detector may be a component that is expensive when the band for analysis does not lie within the absorption spectrum of a material that is industrially widespread, such as silicon.

Documents US 2007/0188764 and US 2007/0070347 describe respective spectroscopy devices, each comprising a filter cell and an emission cell. In both of those documents, the filter cell is no more than a single filter covering the entire emission source.

An object of the present invention is thus to provide a wavelength spectroscopy device that makes it possible to measure a spectrum in transmission or in reflection and that does not present the above-mentioned limitations.

According to the invention, a wavelength spectroscopy device comprises, on a substrate, a filter cell constituted by two mirrors separated by a spacer membrane, the filter cell being made up of a plurality of interference filters; furthermore, the device also comprises an emission cell comprising a plurality of emission sources, each of the sources being associated with one of the interference filters.

The plurality of emission sources makes it possible to use a single detector. The present invention provides a deciding advantage whenever it is less expensive to multiply the number of sources than it is to multiply the number of detectors.

Advantageously, the emission cell is in the form of a plane support that is geometrically similar with the substrate, the emission sources and the interference filters being in alignment along the normal common to the support and to the substrate.

Preferably, the device includes at least one matching cell comprising a plurality of lenses, each of the lenses being associated with one of the interference filters.

In order to optimize the effectiveness of the detector, it is appropriate for the filter cell to be located between the emission cell and the matching cell. This serves to match the size of the filters to the size of the detector.

In a preferred embodiment of the filter cell, at least some of the filters are in alignment in a first strip.

Similarly, at least some of the filters are in alignment in a second strip parallel to and separate from the first strip.

According to an additional characteristic, at least two of the filters that are adjacent are separated by a cross-talk barrier.

The present invention appears below in greater detail from the following description of an embodiment given by way of illustration and with reference to the accompanying figures, in which:

FIG. 1 is a diagram of a spectroscopy device associated with a detector;

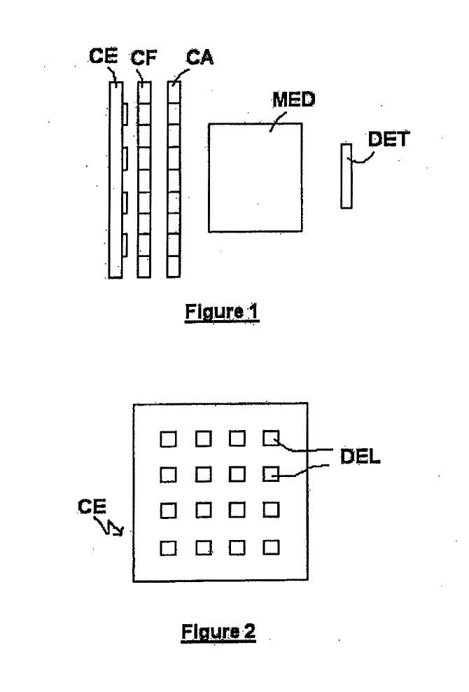

FIG. 2 is a diagram of an emission cell;

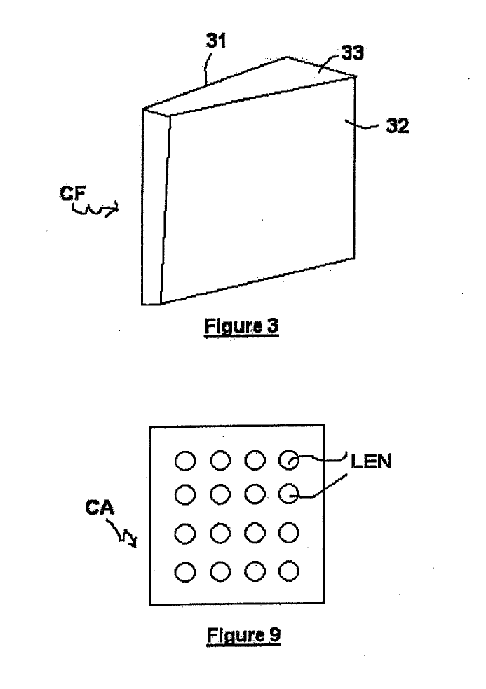

FIG. 3 is a schematic diagram of a first version of a filter cell;

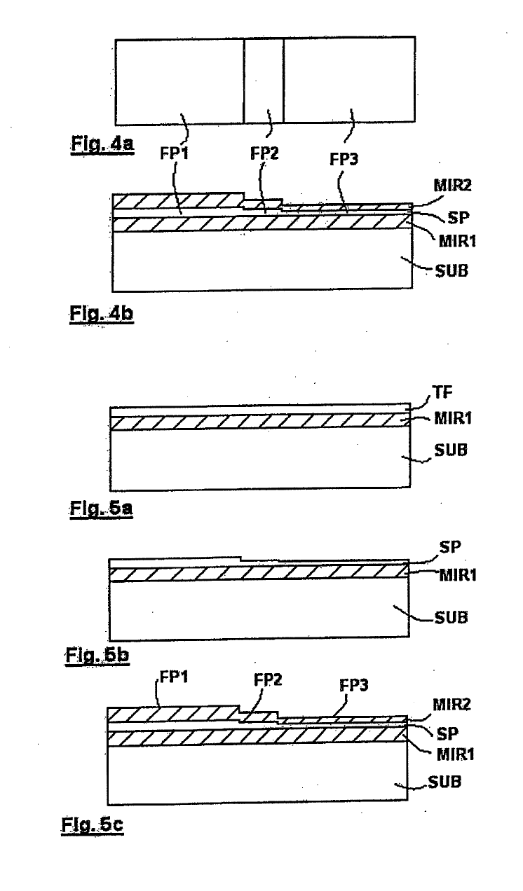

FIG. 4 is a schematic diagram of a second version of a filter cell having one dimension, and more particularly:

FIG. 4a is a plan view of the cell; and

FIG. 4b is a section view of the cell;

FIGS. 5a to 5c show three steps in fabricating a first embodiment of this filter cell;

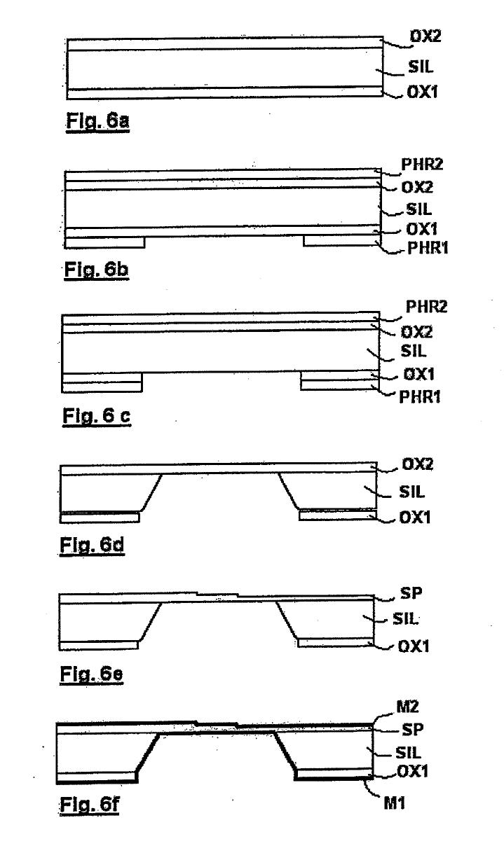

FIGS. 6a to 6f show six steps in fabricating a second embodiment of this filter cell;

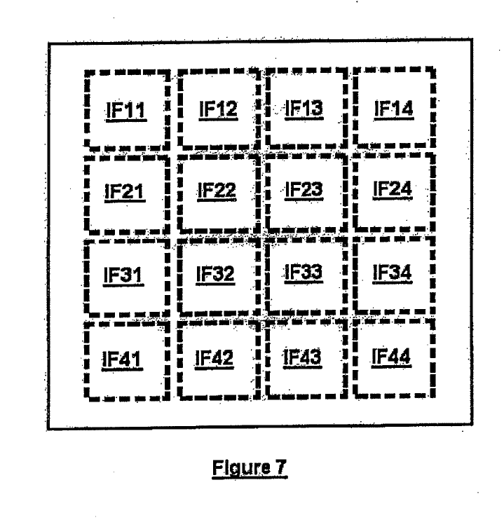

FIG. 7 is a schematic diagram of a filter cell having two dimensions;

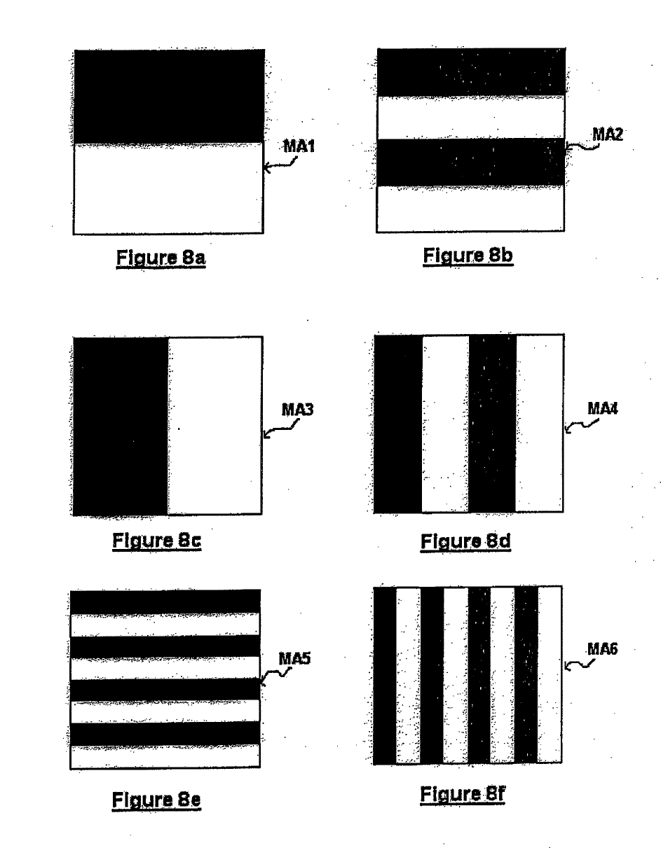

FIGS. 8a to 8f, show respective masks suitable for being used during an etching step; and

FIG. 9 is a diagram of a matching cell.

Elements present in more than one of the figures are given the same references in each of them.

With reference to FIG. 1, the device of the invention is designed to perform transmission analysis of an arbitrary medium MED. It comprises a radiation module essentially comprising an emission cell CE superposed on a filter cell CF and a detection module that, in this example, is no more than a single detector DET. Naturally, the medium MED to be analyzed lies between the radiation module and the detector.

Optionally, at least one matching cell CA is provided for optically matching the radiation module to the detector. In the present example, this matching cell CA is juxtaposed with the filter cell CF, facing the detector DET.

Alternatively, the matching cell could appear between the emission cell CE and the filter cell CF. It is even possible to envisage having two matching cells, one between the emission cell CE and the filter cell CF, and the other juxtaposed with the filter cell CF, facing the detector DET.

With reference to FIG. 2, the emission cell CE comprises an array of individual emission sources DEL arranged in a 4×4 matrix on a support. In the present example, these sources are light-emitting diodes provided by hybridization on the support. This arrangement is given by way of indication since numerous other solutions are available, concentric circles, hexagons, . . . . Similarly, the number of sources is of little importance for implementing the invention.

With reference to FIG. 3, in a first version, the filter cell is analogous to that described in above-mentioned document US 2006/0209413. It is in the form of two plane mirrors 31, 32 that are separated by a spacer membrane 33, one of the mirrors 32 being inclined relative to the other 31.

In a second version, the filter cell adopts a different shape and the principle is explained with reference to FIGS. 4a and 4b by means of three interference filters of the Fabry-Perot type FP1, FP2, FP3 that are aligned in succession so as to form a strip.

This cell is constituted by a stack on a substrate SUB made of glass or of silica, for example, the stack comprising a first mirror M1, a spacer membrane SP, and a second mirror MIR2.

The spacer membrane SP that defines the center wavelength of each filter is thus constant for a given filter and varies from one filter to another. Its profile is staircase-shaped, since each filter has a surface that is substantially rectangular.

A first method of making this filter cell using thin-layer technology is given by way of example.

With reference to 5a, the method begins by depositing the first mirror MIR1 on the substrate SUB, which mirror MIR1 consists of a stack of dielectric layers, of metallic layers, or indeed of a combination of both types of layer. Thereafter, a dielectric layer of a set of dielectric layers TF is deposited in order to define the spacer membrane SP.

With reference to FIG. 5b, the dielectric TF is etched:
initially in the second and third filters FP2 and FP3 in order to define the thickness of the spacer membrane SP in the second filter FP2; and
subsequently in the third filter FP3 in order to define therein the thickness of said membrane.

In the first filter FP1, the spacer membrane SP has the thickness of the deposit.

With reference to FIG. 5c, the second mirror MIR2 is deposited on the spacer membrane SP in order to finalize the three filters.

The spacer membrane SP may be obtained by depositing a dielectric TF and then performing successive etches as described above, however it can also be obtained by performing a plurality of successive depositions of thin layers.

By way of example, the wavelength range 3700 nanometers (nm) to 4300 nm may be scanned by modifying the optical thickness of the spacer membrane.

It should be observed at this point that the thickness of the spacer membrane must be small enough to ensure that only one transmission band is obtained in the range that is to be probed. The greater this thickness e, the greater the number n of wavelengths λ that will satisfy the condition [ne=kλ/2].

A second method of making the filter cell is described below.

With reference to FIG. 6a, the method begins by performing thermal oxidation on a silicon substrate SIL on its bottom face OX1 and on its top face OX2.

With reference to FIG. 6b, the bottom and top faces OX1 and OX2 are covered respectively in a bottom layer PHR1 and a top layer PHR2, each of photosensitive resin. Thereafter, a rectangular opening is formed in the bottom layer PHR1 by photolithography.

With reference to FIG. 6c, the thermal oxide on the bottom face OX1 is etched in register with the rectangular opening formed in the bottom layer PHR1. The bottom and top layers PHR1 and PHR2 are then removed.

With reference to FIG. 6d, anisotropic etching is performed of the substrate SIL (e.g. on the crystallographic orientation 1-0-0) in register with the rectangular opening, the thermal oxide of the bottom face OX1 serving as a mask and the thermal oxide of the top face OX2 serving as a stop layer for the etching. It is possible to use either wet etching by means of a potassium hydroxide (KOH) solution or a trimethyl ammonium hydroxle (TMAH) solution, or else dry etching using a plasma. The result of this operation is that only an oxide membrane remains at the bottom of the rectangular opening.

With reference to FIG. 6e, this oxide is etched:
initially in the second and third filters FP2 and FP3 in order to define the thickness of the spacer membrane SP in the second filter FP2; and
subsequently in the third filter FP3 in order to define the thickness of the membrane SP therein.

With reference to FIG. 6f, the first and second mirrors M1 and M2 are deposited on the bottom and top faces OX1 and OX2 of the substrate SIL.

The preparation of this filter cell may optionally be terminated by depositing a passivation layer (not shown) on one and/or the other of the bottom and top faces OX1 and OX2.

The invention thus makes it possible to provide a set of aligned filters, it being possible for these filters to be referenced in a space of one dimension.

With reference to FIG. 7, the invention also makes it possible to organize such filters in a two-dimensional space in the form of a matrix.

Four identical horizontal strips, each contain four interference filters. The first strip, the strip that appears at the top of the figure, corresponds to the first row of a matrix and comprises filters IF11 to IF14. The second, third, and fourth strips respectively comprise filters IF21 to IF24, filters IF31 to IF34, and filters IF41 to IF44, respectively.

The organization is said to constitute a matrix since the filter IFjk belongs to the j^{th} horizontal strip and also to a k^{th} vertical strip having filters IF1k, IF2k, . . . IF4k.

The method of making the filter module may be analogous to either one of the two methods described above.

The method thus begins by depositing the first mirror and then a dielectric on the substrate. The dielectric is etched:
with reference to FIG. 8a, by means of a first mask MA1 that masks the first two horizontal strips IF11-IF14 and IF21-IF24;
with reference to FIG. 8b, by means of a second mask MA2 that masks the first and third horizontal strips IF11-IF14 and IF31-IF34;
with reference to FIG. 8c, by means of a third mask MA3 that masks the first and second vertical strips IF11-IF41 and IF12-IF42; and
with reference to FIG. 8d, by means of a fourth mask MA4 that masks the first and third vertical strips IF11-IF41 and IF13-IF43.

Thereafter, the second mirror is deposited on the spacer membrane as etched in this way in order to finalize the 16 filters of the 4×4 matrix.

Etching the same depth by means of the various masks is of little interest. However, if it is desired to obtain a regular progression in the thickness of the filters, it is possible to proceed as follows:
etch a depth p by means of the fourth mask MA4;
etch a depth 2p by means of the third mask MA3;
etch a depth 4p by means of the second mask MA2; and
etch a depth 8p by means of the first mask MA1.

It is desirable to separate the various filters of the filter cell clearly in order to avoid any partial overlap of a filter on an adjacent filter and in order to minimize any possible problem of cross-talk. To do this, it is possible to add a grid on the filter cell, the grid constituting a cross-talk barrier for defining all of the filters. This grid should be absorbent if the module is used in reflection or it should be reflecting if the module is used in transmission. By way of example, an absorbent grid may be made by depositing and etching black chromium (chromium+chromium oxide), while a reflecting grid may be made by depositing and etching chromium.

By way of indication, the dimension of the filters is of the order of 500×500 square micrometers (μm²). Naturally other sizes of filter are possible, nevertheless they must be of a size that is sufficient to avoid excessive diffraction phenomena.

The filter cell CF is thus designed to be associated with the emission cell CE in such a manner that each source is in register with a filter.

With reference to FIG. 9, the matching cell CA consists in an array of microlenses LEN arranged likewise in a 4×4 matrix on a transparent plate.

The emission cells CE, the filter cells CF, and the matching cells CA are thus superposed in such a manner that each source DEL is followed by a filter IF and a microlens LEN along an axis perpendicular to the support, to the substrate, and to the plate.

The detector is a standard component. For example, it is made of gallium arsenide if it is desired to operate in the ultraviolet.

It should be observed at this point that mechanical assembly is very simple since there are few optical parts and no moving parts. Measurement is consequently very stable and very reproducible.

The device of the invention may be used in various ways:
simultaneously switching on all of the emission sources in order to obtain an overall spectrum;
switching on the various sources sequentially in order to obtain different spectra corresponding to the filters involved; and
switching on groups of sources sequentially.

The embodiments of the invention described above are selected because of their concrete nature. Nevertheless, it is not possible to list exhaustively all embodiments covered by the invention. In particular, any of the means described may be replaced by equivalent means without going beyond the ambit of the present invention.

1. A wavelength spectroscopy device comprising, on a substrate a filter cell (CF) constituted by two mirrors (31, 32; MIR1, MIR2; M1, M2) separated by a spacer membrane (33; SP), the filter cell being made up of a plurality of interference filters (FP1, FP2, FP3; IF11-IF44), the device being characterized in that it further comprises an emission cell (CE) comprising a plurality of emission sources (LED), each of said sources being associated with one of said interference filters.

2. A device according to claim 1, characterized in that said emission cell (CE) is in the form of a plane support that is geometrically similar with said substrate, said emission sources (LED) and said interference filters (IF11-IF44) being in alignment along the normal common to said support and to said substrate.

3. A device according to claim 2, characterized in that it includes at least one matching cell (CA) comprising a plurality of lenses (LEN), each of said lenses being associated with one of said interference filters (IF11-IF44).

4. A device according to claim 3, characterized in that said filter cell (CF) is located between said emission cell (CE) and said matching cell (CA).

5. A device according to claim 1, characterized in that at least some of said filters (FP1, FP2, FP3; IF11-IF14) are in alignment in a first strip.

6. A device according to claim 5, characterized in that at least some of said filters (IF21-IF24) are in alignment in a second strip parallel to and separate from the first strip.

7. A device according to claim 5, characterized in that at least two of said filters (FP1, FP2, FP3; IF11-IF44) that are adjacent are separated by a cross-talk barrier.
